(19) United States
(12) Patent Application Publication
(10) Pub. No.: US 2012/0074366 A1
(43) Pub. Date: Mar. 29, 2012

(54) FALL PREVENTION BRACKET

(76) Inventor: ALLAN Spear, III, Gainesville, FL (US)

(21) Appl. No.: 12/890,159

(22) Filed: Sep. 24, 2010

(51) Int. Cl. E04H 17/14; E04H 17/00; F16M 13/02

(52) U.S. Cl. 256/59; 248/231.91

(57) ABSTRACT

A safety guard rail system designed to be installed on a wall front-side during construction to provide worker forward fall protection. The embodiments disclosed utilize portable brackets attachable to anchors that have been incorporated into the wall structure during construction. As construction of the wall advances upwards, individual brackets can be easily lifted and coupled to the anchors to provide a secure support for horizontal railings. When the brackets are no longer necessary, the anchors can remain in place to later secure or be covered by façade, or they can be sheared off or bent parallel to the wall. The safety guard rail system of the subject invention provides the advantages of easy assembly and portability during construction.

### BACKGROUND OF INVENTION

Concrete masonry is one of the most common applications used for the construction of small and large structures. Concrete blocks are often used in masonry projects because they are economical, energy efficient, and fire-resistant. They also have the advantage of allowing great architecturally versatility and such structures usually require minimal maintenance.

Typical concrete block is a rectangular 8×8×16 inch (200×200×400 mm) piece formed of cement, gravel, sand, and water. Other components can be included to impart color, entrain air, provide water resistance, or other features. The blocks are assembled by stacking and are maintained in place with a mortar or cement layer therebetween. Oftentimes, the walls must be shored up or supported after being constructed until the concrete or mortar “cures” and the structures can support themselves.

Constructing concrete masonry walls can be dangerous because of the tremendous weight of the wall that often needs to be supported during the curing process. For large structures of significant height, guard rail systems, safety nets, personal fall protection devices, and other methods are often utilized to protect workers during construction. The Occupational Safety and Health Administration (OSHA) requires the use of guard rails on the backside and ends of scaffolding to protect workers from falling from a height of 10 feet or more. Also, because hands often grab guard rails during the course of a day, OSHA requires that guard rail systems be surfaced to protect workers from punctures or lacerations and to prevent clothing from snagging. The ends of top-rails and mid-rails are not allowed to overhang terminal posts either, unless the overhang does not constitute a projection hazard.

In addition to falling off a scaffold, workers must also be wary of forward falls. Usually, if the masonry or block is being laid against another building wall, there is no forward fall hazard, so it is not necessary to use guard rails on the front or working side of the work platform. However, if the structural wall is a stand-alone wall, then there would be no “front wall” barrier immediately behind the new wall. As the wall construction progresses, fall protection measures should be taken. However, it is not practical to have guard rails and support posts on the front side of the scaffolding or the backside of the wall, as it would significantly interfere with the work of placing the masonry.

One alternative to scaffolding is the use of a personal fall restraint system, typically a fall arrest lanyard or similar device affixed to the scaffolding or other secure anchor structure, by workers laying block and working on the forward edge of the work platform. However, the use of personal fall restraint systems also significantly hampers the efficiency of workers, because of the necessity of repeatedly moving or re-anchoring the lanyard.

One alternative to using personal fall restraint systems is to install front-wall safety guard rails on the front side of a wall as it is being constructed. The advantage of front-wall safety guard rails is that they provide a forward fall protection system that allows workers greater freedom of movement and efficiency. A typical front-wall safety guard rail system utilizes multiple vertically-aligned brackets spaced apart and attached to the front side of the wall and wood slats, often 2×4 inch boards, placed horizontally therebetween. The Occupational Safety and Health Administration (OSHA) requires that such guard rail systems be capable of withstanding a force of at least 200 pounds applied within 2 inches of the top edge in any outward or downward direction. When the 200-pound test is applied in a downward direction, the top edge of the guard rail must not deflect to a height less than 39 inches above the walking or working level. The mid-rails of a guard rail must be capable of withstanding a force of 150 pounds applied in any downward or outward direction.

Current procedures require attaching the brackets to the constructed and cured wall section using screws or other permanent securing methods. But, this system is not ideal because once the wall has been constructed above a certain height, the safety guard rail system must be removed and reinstalled at the higher level before work can continue. Repositioning the front-wall safety guard rail requires removing the screws or other attachment means from the first height and then re-attaching the guard rail at a higher level. This can be a time-consuming endeavor. Further, an unfortunate consequence is that more holes must be made in the wall each time the guard rail is re-installed, which can require later repair or a least sealing of any holes, cracks or other openings made during attachment.

There is an ongoing need for a front-wall safety guard rail system that meets construction safety regulations, that is easy to install and move as necessary to different heights, and which does not damage or deface the front side of a wall being constructed.

### BRIEF SUMMARY

The embodiments of the subject invention successfully address the above described disadvantages associated with previously known front-wall safety guard rail devices and methods, and provide certain attributes and advantages, which have not been realized by these known devices. In particular, the subject invention provides novel, easy to use, non-defacing, portable, and highly effective methods and devices for installing a front-wall safety guard rail on the front side of a masonry wall being constructed. The embodiments of the methods and devices of the subject invention meet all of the requirements for protecting workers during masonry construction, but are easy to install and move during the construction process.

In general, the embodiments of the subject invention utilize portable fall prevention brackets having a brace used in conjunction with wall anchors. Advantageously, the wall anchors are installed between masonry units, blocks, or bricks, within the mortar or cement layer, during construction and extend from the front side of the wall. As the wall cures, the anchors become secure and are capable of supporting the brackets and the final guard rail system. When the wall reaches a certain height, a worker on a scaffold on the back side of the wall can lift a bracket, removing it from a lower anchor and placing it on a higher anchor in the cured wall. Once a series of two or more brackets has been installed, one or more wood slats can then be placed horizontally within supports on the brackets to form the guardrail system. At the end of construction, the guard rail system can be easily disassembled and reused and the wall anchors can simply remain in place to later anchor wall façades or other additions to the wall, or the anchors can be cut or bent flush with the wall without causing any damage or defacement.

Thus, in accordance with embodiments of the invention, the difficulties of providing a front-wall safety guard rail system that is easy and quick to install with minimal damage to a wall is solved by the portable fall prevention bracket and wall anchor system disclosed herein. The methods and devices embodied herein meet worker safety requirements and provide increased efficiency during masonry construction.

### BRIEF DESCRIPTION OF DRAWINGS

In order that a more precise understanding of the above recited invention can be obtained, a more particular description of the invention briefly described above will be rendered by reference to specific embodiments thereof that are illustrated in the appended drawings. It should also be understood that the drawings presented herein may not be drawn to scale and that any reference to dimensions in the drawings or the following descriptions are specific to the embodiments disclosed. Any variations of these dimensions that will allow the subject invention to function for its intended purpose are considered to be within the scope of the subject invention. Thus, understanding that these drawings depict only typical embodiments of the invention and are not therefore to be considered as limiting in scope, the invention will be described and explained with additional specificity and detail through the use of the accompanying drawings in which:

FIG. 1 is an illustration of a side elevational view of an embodiment of a bracket of the subject invention installed against a structure.

FIG. 2A is an elevational view of the beam back-side of an embodiment of a bracket of the subject invention.

FIG. 2B is an elevational view of the beam back-side of an alternative embodiment of a bracket of the subject invention. Illustrated is a beam having a two-tined proximal end.

FIG. 2C is an elevational view of the beam back-side of an alternative embodiment of a bracket of the subject invention. Illustrated is a beam having a two-tined distal end.

FIG. 3 is a side elevational view of an embodiment of a bracket of the subject invention. Illustrated are examples of rail supports.

FIG. 4 is an elevational view of the beam front-side of an embodiment of a bracket of the subject invention.

FIG. 5 is a side elevational view of an embodiment of a bracket of the subject invention. Illustrated is one embodiment of a rail support with two attached ends.

FIG. 6 is a cut-away side view of a cured wall, floor support in place, showing an anchor support in positioned between two concrete blocks. In this embodiment, the anchor support extends across the width of the cement block so that the second angled end can be seen extending out from the wall back-side.

FIG. 7 is a cut-away side view of wall being constructed showing an anchor support in place between two concrete blocks.

FIGS. 8A-1 through 8A-6 illustrate examples of different anchor embodiments that can be used with the subject invention. FIG. 8A-1 illustrates a specific embodiment having two oppositely angled ends. FIGS. 8A-2 through 8A-4 illustrate embodiments with different angle configurations for buttressing against the inside and/or outside of a concrete block. FIG. 8A-5 illustrates an embodiment where the second angled end is turned 90° to be secured to rebar or other structure within a concrete block wall. FIG. 8A-6 illustrates an embodiment where the second angled end is configured in a circular or hook-like configuration for specifically securing to vertical rebar within a concrete block.

FIG. 8B is a photograph showing an example embodiment of an anchor embedded within a cement block wall.

FIG. 8C illustrates one embodiment of an anchor housing of the subject invention.

FIG. 8D is a photograph showing one embodiment of a brace coupled to an embodiment of an anchor embedded within a cement block wall.

FIG. 9 is an illustration of one embodiment of a safety guard rail system of the subject invention in place against a wall front-side.

FIG. 10 is a photograph of one embodiment of a bracket of the subject invention coupled to an anchor secured within a partially built wall.

### DETAILED DISCLOSURE

The subject invention in general describes embodiments of a guard rail system. More specifically, the subject invention pertains to one or more embodiment(s) of front-wall safety guard rail devices and methods, or a similar device, capable of providing worker forward fall protection during construction of a masonry wall.

The following description will disclose that the subject invention is particularly useful in the field of construction, in particular the construction of masonry structures utilizing cement block or brick. However, a person with skill in the art will be able to recognize numerous other uses that would be applicable to the devices and methods of the subject invention. While the subject application describes a use for protecting workers during masonry wall construction, other modifications or alternative uses that would be apparent to a person with skill in the art having benefit of the subject disclosure are contemplated to be within the scope of the present invention.

In the description that follows, a number of terms used in the field of construction are utilized. In order to provide a clear and consistent understanding of the specification and claims, including the scope to be given such terms, the following definitions are provided.

As used herein, the term “wall front-side” refers to the side of a vertical wall that faces away from a worker and/or scaffolding. Likewise, the term “beam front-side” refers to the portion of the beam that, when installed against a wall, faces substantially away from a worker.

Also as used herein, the term “wall back-side” refers to the side of a vertical wall that faces towards a worker or the side against which scaffolding is placed. Likewise, the term “beam back-side” refers to the area of the beam that, when installed against a wall, faces substantially towards a worker.

The terms “block course” or “block layer” refers to a layer of brick, cement block, or similar structures placed end to end and held in place with mortar or concrete.

In addition, as used herein, and unless otherwise specifically stated, the terms “operably connected”, “operably coupled” or “cooperatively engaged” mean that the particular elements are connected in such a way that they cooperate to achieve their intended function or functions. The “connection” may be direct, or indirect, physical or remote.

Finally, reference is made throughout the application to a “proximal end” and a “distal end.” As used herein, the proximal end is that end highest on the front wall when a bracket is operably connected to an anchor. Conversely, the distal end is that end lowest on the front wall when the bracket is operably connected to an anchor.

The present invention is more particularly described in the following examples that are intended to be illustrative only since numerous modifications and variations therein will be apparent to those skilled in the art. As used in the specification and in the claims, the singular for “a,” “an” and “the” include plural referents unless the context clearly dictates otherwise.

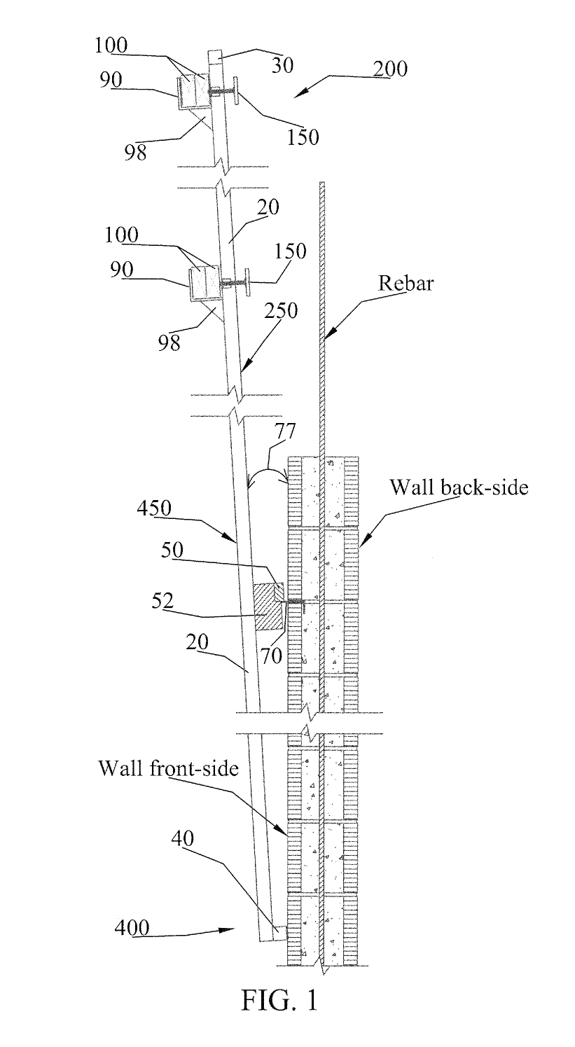

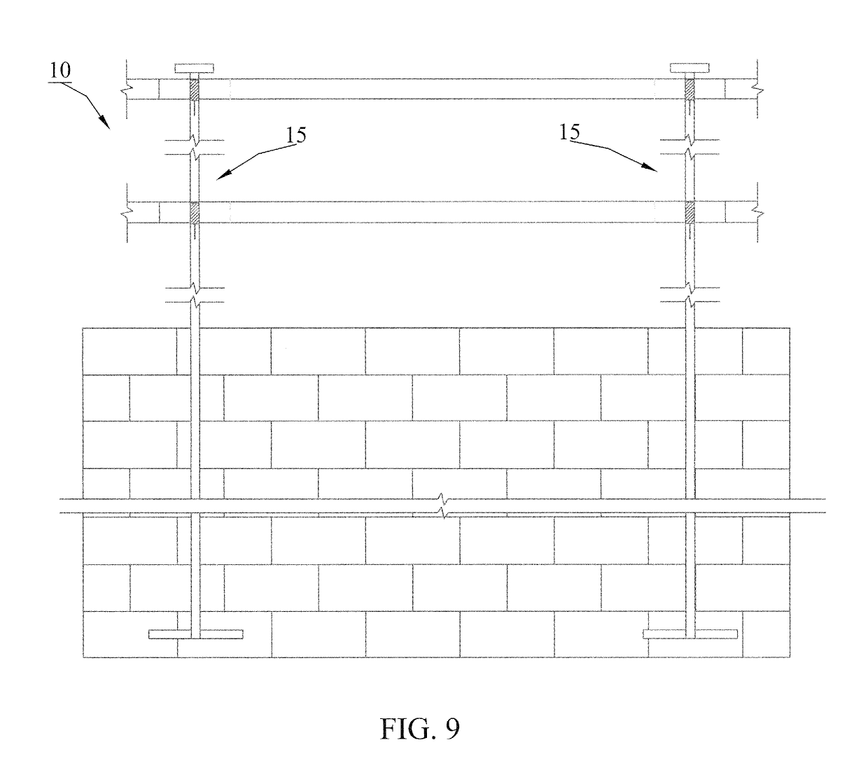

With reference to the attached figures, which show certain embodiments of the subject invention, it can be seen that the front-wall safety guard rail or guard rail 10 of the subject invention generally comprises a series of fall prevent brackets 15 (also referred to herein as “brackets”) that include an elongated beam 20 with a hand grip 30 at or about the proximal end 200 and a footer 40 at or about the distal end 400. Between the hand grip and the footer is a brace 50 coupled to the beam, the brace being operably connectable to an anchor 70. One or more supports 90 can also be coupled to the elongated beam for fixing one or more rails 100 generally perpendicular to the beam. Additional features can be included, as will be discussed herein. FIGS. 1 and 9 illustrate an embodiment of a safety guard rail 10 system in place against a front side of a wall being constructed.

FIG. 1 provides a side view of an embodiment of a bracket 15 of the subject invention in position against a wall front-side. The embodiment in FIG. 1 shows the brace 50 coupled to an embedded anchor 70, which can position the beam 20 substantially vertically with the distal end 400 and a footer 40 against the wall front side for stabilizing the bracket.

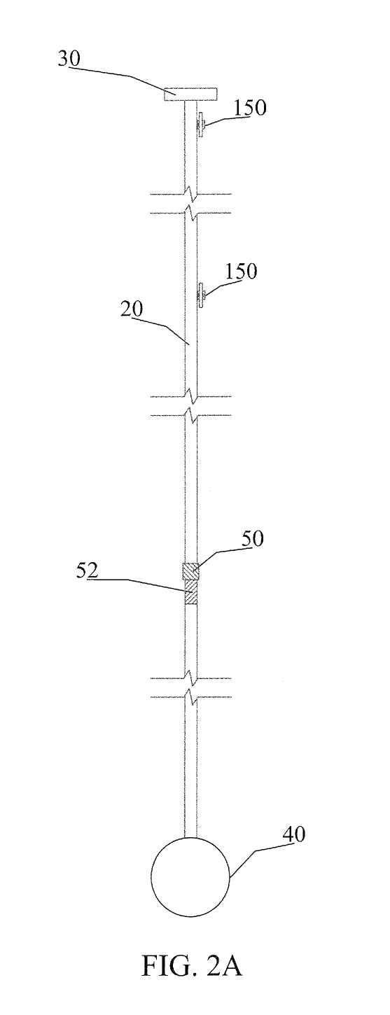

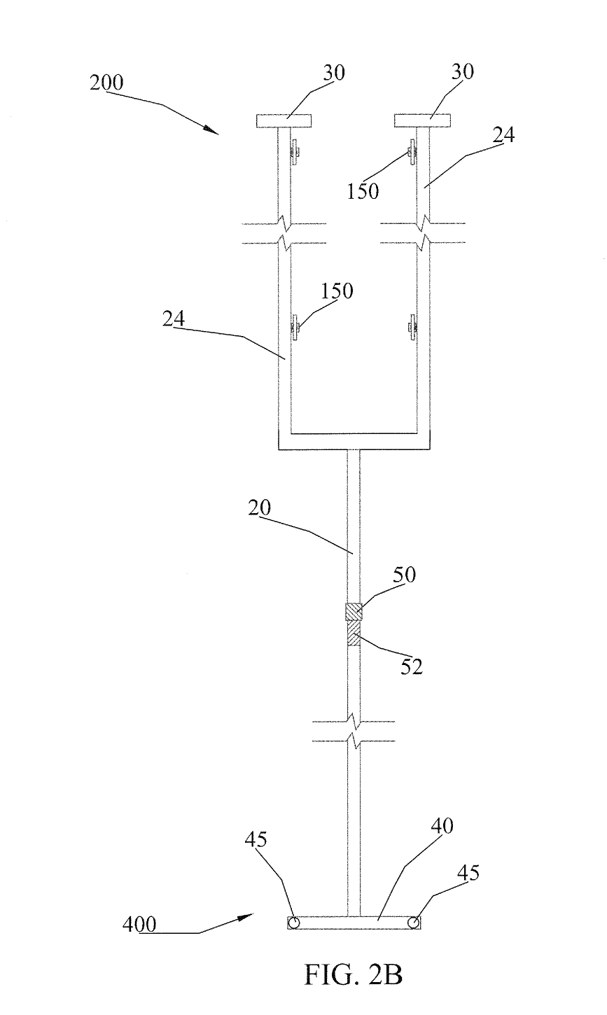

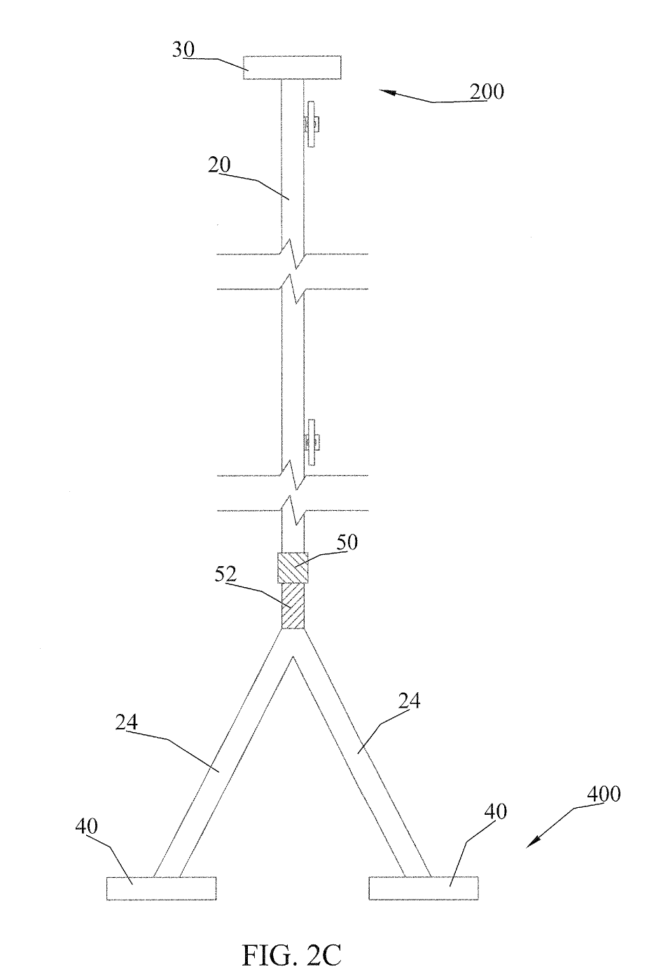

In one embodiment, the beam 20 is generally an elongated rod- or tube-like rigid structure having a single proximal end 200 and a single distal end 400, as seen in FIG. 2A, that can have any of a variety of cross-sectional shapes, including, but not limited to, circular, oval, square, triangular, rectangular, combinations thereof, or any other polygonal shape. The beam can have a hollow or partially hollow center or core or can be solid therethrough.

In an alternative embodiment, the proximal end 200 of the beam 20 and/or the distal end 400 of the beam can have two or more ends or tines 24. In this embodiment, the beam 20 forks or is otherwise divided or branched at some point along its length, such that there can be two or more tines 24 that extend generally towards the proximal and/or distal ends. In one embodiment, the beam can be forked above the brace 50. Alternatively, the beam can be forked below the brace 50, such that there can be a brace on one or more of the tines 24. In yet another alternative embodiment, a brace can be positioned between two or more tines, to better balance the bracket. A general example of these embodiments is illustrated in FIG. 2B, which shows a proximal end with two tines, and in FIG. 2C, which illustrates a distal end with two tines. A person with skill in the art would be able to devise any of a variety of alternative beam designs that include multiple tines and a brace advantageously positioned relative thereto. It is contemplated that such alternative embodiments are within the scope of the present invention.

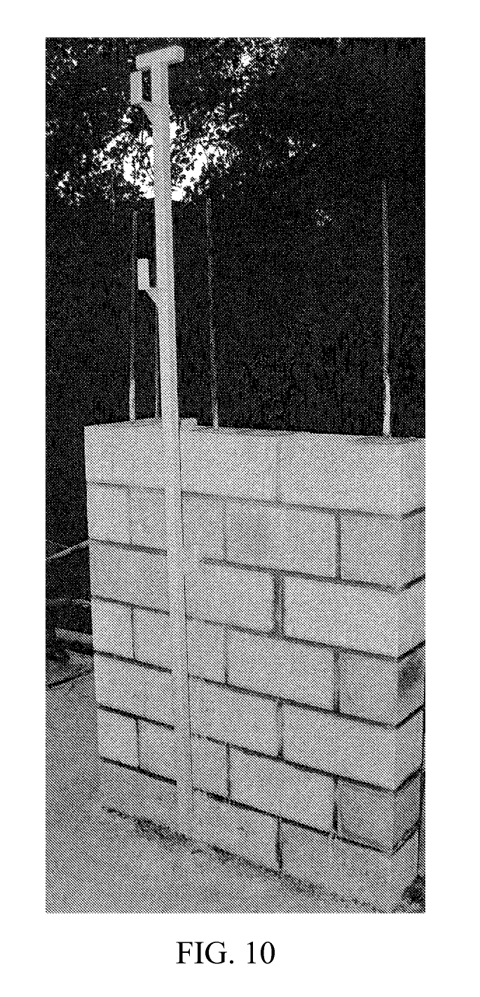

The length of the beam 20 can vary depending upon a variety of factors known to those with skill in the art, including, but not limited to, the intended use of the bracket, the working height, the type of construction, and other factors. For example, in constructing concrete block masonry structures, it can be desirable for the safety guard rail 10 to extend above the walking or working level to a height of between approximately 3-5 feet, as illustrated, for example, in FIG. 9. Further, to provide sufficient stability and flexibility to the beam, the length can extend approximately 3-5 feet below the walking or working level, which is also illustrated, for example, in FIG. 9. Therefore, in one embodiment the beam can be between approximately 6 feet and approximately 10 feet in length. In a particular embodiment, the beam can be between approximately 7 feet and approximately 9 feet in length. In a specific embodiment, illustrated for example in FIG. 10, the beam is approximately 8½ feet in length.

With regard to the material(s) utilized for the beam, any of a variety of materials or products can be used alone or in combination to construct a beam. Any material that provides sufficient and required strength and flexibility can be suitable. Ideally, the materials utilized would allow for repeated use of a bracket. A further consideration would be the overall weight of the bracket, which should not be prohibitive to installation or re-positioning during use. Other factors that may be considered are the type and construction of the structure on which the bracket is to be used, environmental factors, duration of installment, and/or other factors known to those skilled in the art. By way of non-limiting examples, wood, plastics, metal, fiberglass, ceramic materials, and combinations thereof could all be used. However, it will be understood that a wide variety of other materials can be used for beam manufacture and would be apparent to a person with skill in the art having benefit of the subject disclosure. Any and all such variations are contemplated to be within the scope of the subject invention.

Current requirements for building construction state that when a 200-pound test is applied in a downward direction, the top edge of a safety guard rail 10 must not deflect to a height of less than 39 inches above the walking or working level. In other words, the safety guard rail must not bend or flex below a height of 39 inches, when a 200-lb force is applied. Therefore, it can be advantageous if the selected beam material and the length of the beam are capable of maintaining this, or any other, height requirement, even with an acceptable or expected amount of flexibility.

In one embodiment, steel tubing is utilized for the beam. In a more specific embodiment, square steel tubing of approximately 1.5 inch×1.5 inch is employed for the beam. An example of this embodiment is shown in FIG. 10. With this specific embodiment, over two hundred pounds of downward force applied to a beam 8½ feet in length will cause flexion, but the guard rail will maintain the currently required height of 39 inches above the working level.

When installed for use, the distal end 400 of a beam 20 is braced against the constructed wall, as seen in FIGS. 1, 9 and 10. Force applied in the direction of the beam back-side of the safety guard rail 10 is distributed against the wall where the distal end makes contact, as well as by the coupling of the beam 20 to an anchor 70, which will be detailed below. It can be beneficial if the force applied by the distal end to the wall is more evenly distributed, to prevent damage to the wall, such as puncturing of cement blocks or bricks, if significant force is applied. In one embodiment, a footer 40 is used at the distal end to distribute distal end 400 forces against the wall. Advantageously, a footer can also add stability to the beam, reducing or eliminating sliding or rotation of the beam against the wall.

The footer can be any of a variety of structures attached to the distal end of the beam and capable of distributing force. In one embodiment, the footer 40 is a panel or disc of rigid material affixed at or near the distal end of the beam. In a further embodiment, the disc is affixed to the beam back-side at the distal end, one example of which is shown in FIG. 2A. In a specific embodiment, the distal end is affixed approximately in the center of the footer. But, it should be understood that the distal end could be affixed to the disc in any of a variety of positions to achieve the intended purpose. When the beam is installed, the disc can be pressed against the wall. The dimensions of a disc can vary, but should be such that when force is applied to the distal end of the bracket, it can be distributed by the disc across a larger area of the wall, reducing or eliminating the possibility of damage to the wall. In one embodiment, the overall dimensions of a disc provide a contact surface area of between approximately 36 inches and approximately 256 inches. In a more particular embodiment, the overall dimensions of a disc provide a contact surface area of between approximately 100 inches and approximately 144 inches.

In another embodiment, the footer 40 is generally an elongated rod- or tube-like rigid structure. The elongated footer can be affixed at or near the distal end of the beam back-side to facilitate contact with a structure. In a particular embodiment, the distal end is affixed at generally the center of the elongated footer. However, as stated above, it should be understood that the distal end could be affixed to the elongated footer in any of a variety of positions to achieve the intended purpose. The elongated footer can also be affixed at any angle. In one embodiment, a single elongated footer is attached generally horizontal to the beam. But, alternative embodiments can employ more than one elongated footer, each affixed at a different angle. For example, two footers could be affixed in an “X” configuration at the distal end. Alternative embodiments that would be apparent to a person skilled in the art are considered to be within the scope of the subject invention.

The factors that can be considered by those skilled in the art with regard to the choice of materials for each of the components of the subject invention have been discussed above and are reasserted here with regard to the footer. In a particular embodiment, the footer is constructed of steel or some other similarly rigid material. In a more specific embodiment, the footer is constructed of 1½ inch×1½ inch square steel tubing. It will be understood by those with skill in the art that the length of a footer can vary. In one embodiment, the length of a footer is between approximately 6 inches and 24 inches. In a more particular embodiment, the length of a footer is between approximately 10 inches and 20 inches. In a specific embodiment, the length of a footer is approximately 16 inches.

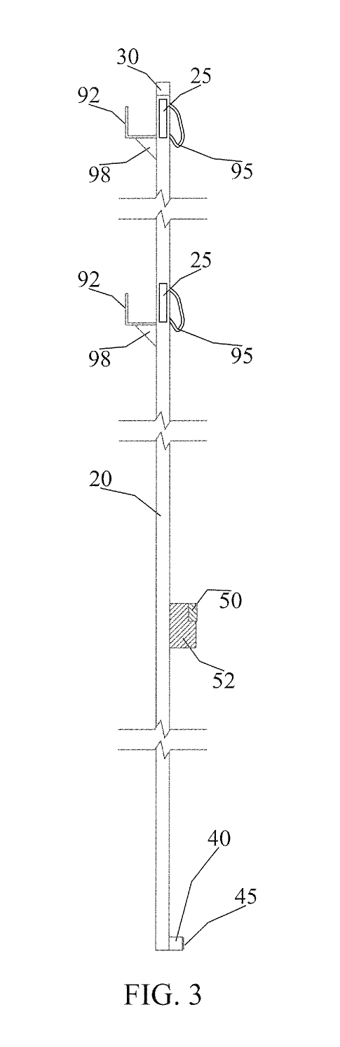

In further embodiments, various types of paddings, coverings, anti-slide devices, coatings, or other materials, generally referred to as stops 45 can be used with a footer to provide further protection to a wall or other structure against which the footer may be placed and/or to further reduce or prevent movement of a footer. FIGS. 2B and 3 illustrate examples of stops that can be used with the embodiments of the subject application.

As mentioned above, one advantage of using the fall prevention brackets 15 of the subject invention is the portability and ease of installation. When it becomes necessary to move a safety guard rail system 10 of the subject invention, each bracket 15 can be lifted from a current position against a wall or structure and moved to a different, often higher, position. Typically, a person standing on scaffolding or other supporting structure on the wall back-side is able to reach over to the wall front side, grasp the proximal end 200 of a bracket 15, lift it, and place it on a different anchor. To facilitate lifting of the bracket 15, the proximal end 200 of a bracket tine 24 can be configured with one or more handgrips 30. Handgrips can be any of one or more rigid, semi-rigid, or flexible attachments that permit the bracket 15 to be lifted from or about the proximal end. A handgrip can be any attachment that benefits the process of lifting a bracket. A handgrip can also include various ergonomic features to better aid grasping and/or lifting of a bracket. Further, a handgrip can be designed for one or two handed lifting of a bracket.

In one embodiment, a handgrip 30 is a generally rod- or tube-like rigid structure. In a particular embodiment, shown, for example, in FIGS. 2A and 3, the handgrip 30 is a rigid elongated structure affixed in a horizontal position at the terminal end of a bracket tine 24. In an alternative embodiment, the handgrip can be affixed to the beam back-side 250 and/or the beam front-side 450 side as desired. In a specific embodiment, a handgrip is configured of 1½ inch×1½ inch steel tubing. In a further embodiment, the length of a handgrip is between approximately 4 inches and 10 inches. In a particular embodiment, the length of a handgrip is between approximately 4 inches and 8 inches. In a specific embodiment, the length of a handgrip is approximately 6 inches.

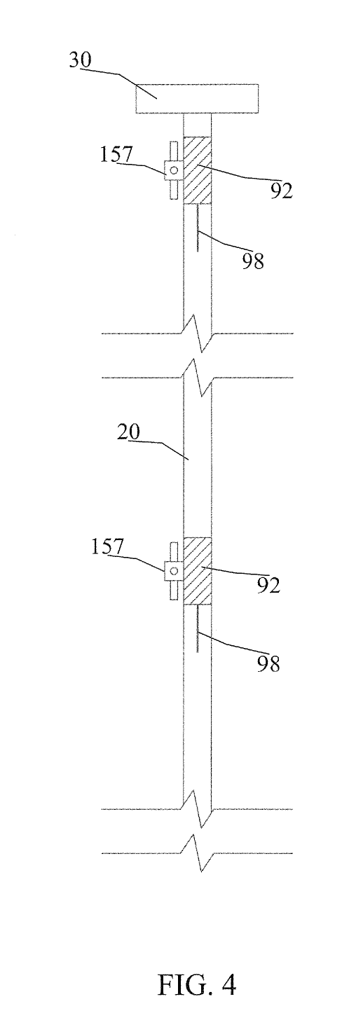

The handgrip can be affixed at any point on the proximal end of the beam, including, but not limited to, the center of a handgrip or at or about one end. In a particular embodiment, the proximal end of the beam is affixed at generally a center point on the handgrip, as seen, for example, in FIGS. 2A, 2B, and 4. In an alternative embodiment, the proximal end of the beam is affixed at or about one end of a handgrip. However, it should be understood that the proximal end could be affixed to a hand grip in any of a variety of positions to achieve the intended purpose. Further, one or more hand grips 30 can be affixed at any of a variety of angles. By way of a non-limiting example, two handgrips can be affixed to the proximal end at specific ergonomically beneficial angles that encourage and provide comfortable two-handed lifting and placement of a bracket.

Alternative embodiments can utilize a more flexible or semi-flexible type of hand grip. For example, a length of some flexible or semi-flexible material, such as, but not limited to, rope, chain, wire, strapping, banding, or other similar structures or combinations thereof, can be affixed to the beam to facilitate lifting. The considerations for attachment of a semi-rigid or flexible handgrip would be the same or similar to those for attachment of one or more rigid handgrips, as discussed above, and are reasserted here.

To construct a safety guard rail according to embodiments of the subject invention, at least one and typically two or more brackets are affixed to a wall or other structure. The attachment of a bracket to a structure can be achieved by a variety of techniques and devices. As discussed above, a typical front-wall safety guard rail system currently used in the art utilizes multiple vertically-aligned brackets that are fixedly attached to a structure with devices that are secured to the wall such as, but not limited to, screws, rivets, posts, nails, or other similar attachment devices. The disadvantage of this system is that removal of the safety guard rail requires that each of these attachment devices be removed to disengage the bracket, often leaving multiple openings within the structure. A further disadvantage is the amount time necessary to attach and unattach each bracket.

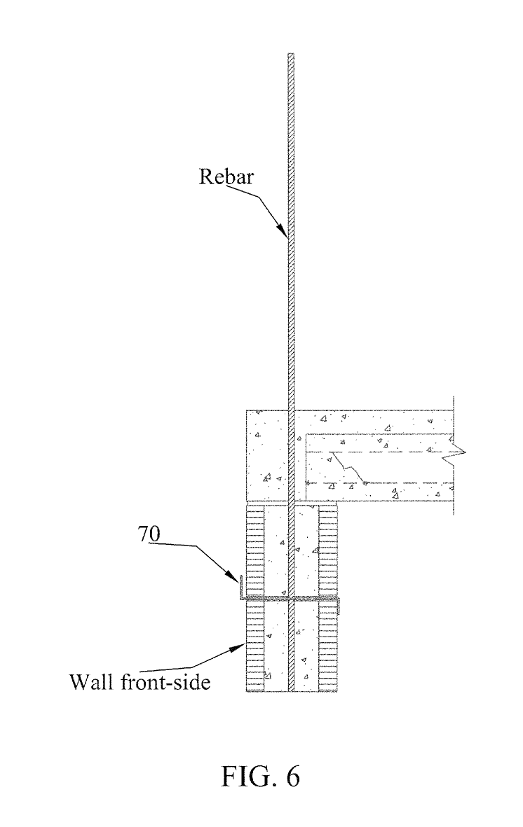

Advantageously, embodiments of the subject invention utilize devices and methods that do not require manipulation of attachment devices to reposition a safety guard rail. A further advantage is that the appearance and integrity of the structure does not have to be affected by placement of the embodiments of a safety guard rail of the subject invention. Unlike the typical safety guard rail systems currently in use, the embodiments of the subject invention employ rigid anchors 70 that can be permanently installed within a structure, such as, for example, between the cement blocks or bricks of a masonry wall. FIG. 6 illustrates one example of an anchor 70 permanently affixed within a masonry wall. As can be seen in FIG. 6, an anchor of the subject invention can extend from the wall front-side to form a protrusion or hook-like structure onto which a brace 50 on a bracket 15 can be positioned. The anchors can then be left in place after the brackets are moved causing no harm or defacement to the wall or structure. Later, if desired, the anchors can be used to secure a wall façade or other structures, or they can be sheared off or bent to be flush with the wall.

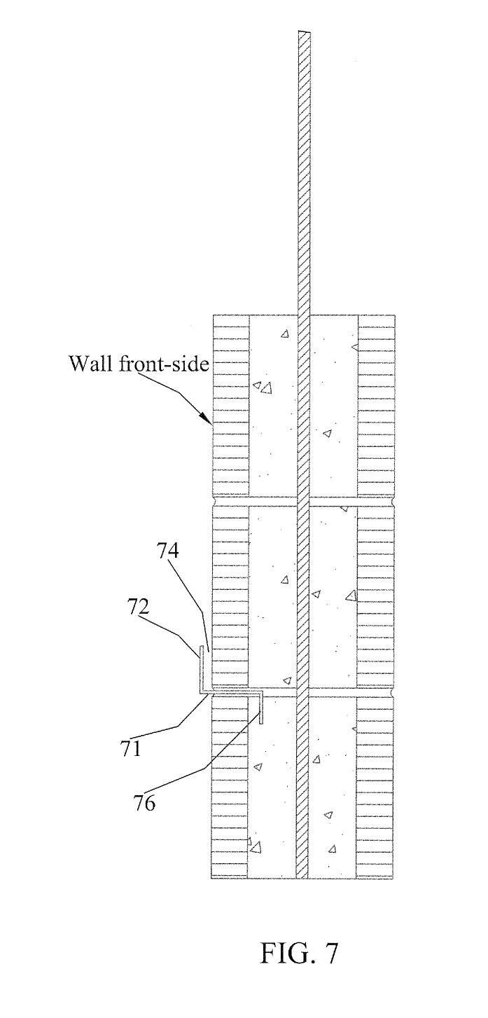

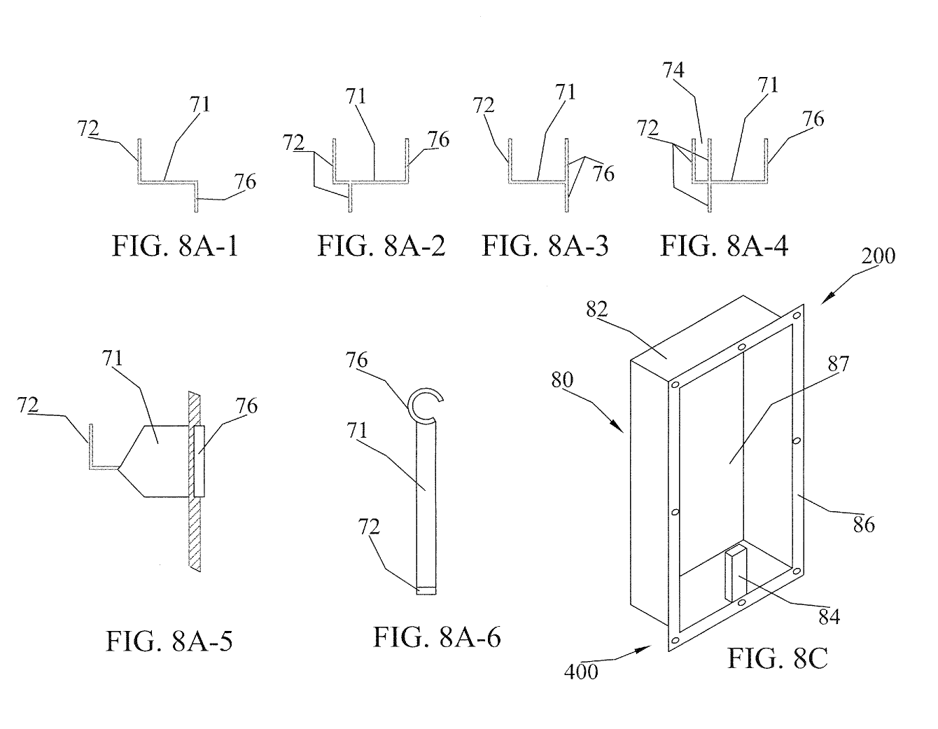

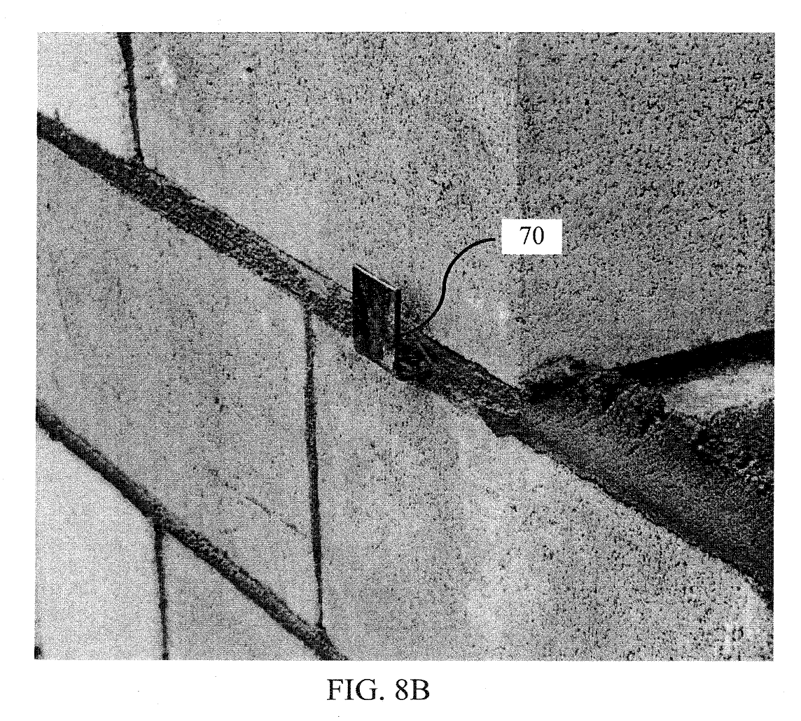

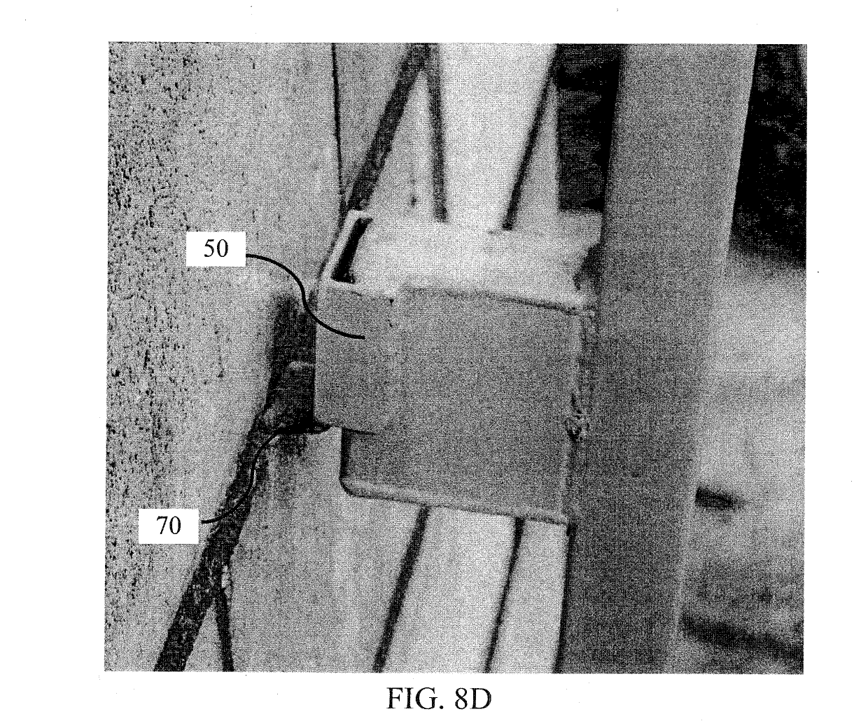

An anchor 70 can assume any of a variety of configurations that are capable of maintaining a secure attachment with a wall or other structure and operably coupling with a bracket. In a simplest form, an anchor can be, in general, an elongated flange 71 having at least one first angled end 72 and at least one second angled end 74, illustrated, by way of non-limiting examples in FIGS. 8A-1 through 8A-5. With this embodiment, an anchor is placed as shown in FIG. 7, where a first angled end 72 protrudes from a wall front-side so that it extends generally proximally 200, forming an upward projection for coupling with a bracket. In a further embodiment, the first angled end 72 protrudes from the wall front-side creating a gap 74 between the wall front-side and the first angled end 72, as shown, by way of example, in FIG. 8B. As will be discussed in more detail below, the gap 74 can facilitate coupling with a bracket 15 and the size of the gap can help to dictate the angle 77 at which the bracket is secured against the wall. In one embodiment, an anchor is installed with ½ inch gap between the first angled end 72 and the wall front-side. As will be discussed below, this can support a bracket coupled thereto at an angle in the proximal direction of between approximately 4° and approximately 6°, inclusive. An increase in the gap 74 size can increase the angle between the bracket and the wall front-side, thus increasing the distance between the proximal end and the structure.

A second angled end 76 of a bracket can be placed within the interior of a wall being constructed. For example, the second angled end 76 can extend into the interior of a cement block, for example, as shown in FIG. 7, and be buttressed against the inside of the cement block to prevent the anchor from being pulled out of the wall. Alternatively, an anchor can have sufficient length that the second angled end can extend through the wall and protrude from the wall back-side, as seen for example, in FIG. 6. In a specific embodiment, an anchor is approximately 2⅝ inches in total length, that is, from the first angled end to the second angled end, with a first angled end extending proximally approximately 2 inches and a second angled end extending distally approximately 2 inches with an overall width of approximately 1½ inches. FIG. 7 illustrates an example of this embodiment.

In yet another alternative embodiment, a second angled end can extend into the interior of a cement block or brick and be secured to a secondary structure therein, such as, for example, rebar, wood framing, or other wall support mechanism, on the interior of a cement block or brick or other structure. FIG. 8A-6 illustrates an example of this embodiment, wherein the second angled end is turned 90° relative to the first angled end, so that it can be secured around a vertical rebar, often utilized within a cement block wall. Alternatively, the second angled end can be configured with a hook-like structure that can be secured around a vertical rebar. FIG. 8A-7 illustrates an example of this embodiment.

In general, embodiments of a wall anchor include at least one first angled end 72 that can operably connect with the bracket and a second angled end 76 that can be secured to or within a structure to ensure that the anchor is not pulled out of or come through the structure. A person with skill in the art and having benefit of the subject disclosure would be able to devise any of a variety of anchor embodiments that would be usable with a bracket of the subject invention. Substitutions of anchor embodiments, other than those specifically exemplified herein, are contemplated to be within the scope of the subject invention.

An alternative embodiment utilizes an anchor housing 80 designed to be installed within a structure. In one embodiment, an anchor housing is a hollow receptacle 82 having any of a variety of sizes and/or shapes that can be inserted within a pre-formed opening within a structure, such as, for example, a masonry wall. A front face opening 87 in the anchor housing opens onto the wall front-side. FIG. 8C illustrates an example of this embodiment. The anchor housing can be secured in place by any method or device known to those with skill in the art. By way of a non-limiting example, one or more flanges 86 located around the periphery of the front face opening 87 can be secured around the edge of the pre-formed opening in the structure, not unlike a typical wall electrical outlet housing.

In a further embodiment, at least one tang 84 is fixedly situated within the anchor housing for coupling with a brace 50, similarly to a first angled end 72, described above. In one embodiment, a tang is fixedly attached at or about the bottom or distal end 400 of the anchor housing and points generally upwards or in a proximal 200 direction. FIG. 8C illustrates an example of this embodiment. To secure a bracket 15 against a structure, the brace 50 on a bracket can be inserted into the anchor housing and lowered onto the tang 82.

Use of anchor housings can be most efficacious for permanent or long term use on structures where brackets and/or safety guard rail systems may be assembled and disassembled numerous times. The use of anchor housings can help maintain a smooth appearance to a wall front-side and are easily used when brackets are lifted and moved to a new position.

The coupling of the bracket to an anchor can be accomplished by any of a variety of methods and devices. In general, the bracket can include any rigid, semi-rigid, or flexible apparatus, structure, attachment, or configuration capable of being coupled to an anchor 70 to securely hold a bracket 15 against a wall or other structure. In one embodiment, the bracket includes a rigid brace 50 on the beam back-side 250. A brace can be any structure capable of coupling with or otherwise receiving the first angled end 72 of an anchor 70. In a particular embodiment, a brace 50 is a substantially tubular or other hollow or semi-hollow structure affixed parallel to the beam back-side, where one end of the tube opens towards the distal end 400. With this embodiment, the brace can be placed over a first angled end, which, as described above, extends generally proximally 200. An example of this can be seen in FIG. 8D. Also, as mentioned above, the gap 74 can allow a brace to be placed over or around a first angled end. One the brace is placed over the first angled end, the distal end of the beam and/or the footer can rest against the structure, forming an angle 77 towards the proximal end. Further, as mentioned above, the size of the gap can help to dictate the angle 77 of the bracket against the wall. Increase in the gap size will increase the angle in the proximal direction and keep the safety guard rail system 10 an adequate distance from the work area, but close enough to workers to still ensure protection if they should fall forward.

In an alternative embodiment, a brace 50 can be extended a pre-determined distance from the bracket to increase the angle 77, when the distal end of the beam and/or footer is placed against the structure. In yet another alternative embodiment, a brace can be attached to a spacer 52 that is affixed to the beam to increase the angle 77 between the beam back-side and the structure. FIG. 8D shows one example of an embodiment utilizing a spacer. The distance of the bracket from the beam, the location of the bracket on the beam, the size of a spacer, and/or the anchor gap can all affect the angle 77 of the bracket relative to a structure. As such, the dimensions and characteristics of each of these components should be considered when determining the angle at which a bracket will be placed against a structure.

In a specific embodiment, a tubular brace of 16 gauge steel and approximately 2″W×2″H×1″L is fixedly attached to a spacer 52 that extends approximately 3″ from the beam back-side. The distal end of the brace can be approximately 37 inches from the distal end of the beam. This embodiment, when coupled to an anchor that provides a ½″ gap, forms an angle 77 between the beam and a wall or other structure that is between approximately 4° and approximately 6°, inclusive. This, in turn, causes the proximal end of the bracket to veer away from the structure between approximately 5″ and approximately 10″ from the wall front-side, giving ample working space.

One of the main purposes of the bracket 15 embodiments of the subject invention is to support and maintain a railing running generally parallel to the working level. To accomplish this, one or more elongated rails 100 can be coupled between brackets. Such coupling with the brackets can be achieved by any one or more of several methods and devices known to those with skill in the art. By way of a non-limiting example, one or more rails can be removably attached directly to a beam using any of various types of nuts and bolts, lugs, pins, rivets, screws, or other attachment devices known to those with skill in the art. In an alternative embodiment, a beam 20 can have one or more openings or slots 25 for receiving and supporting one or more rails. FIG. 3 illustrates an example of this embodiment where two slots 25 extend through the beam forming a channel between the beam front-side 450 and the beam back-side 250.

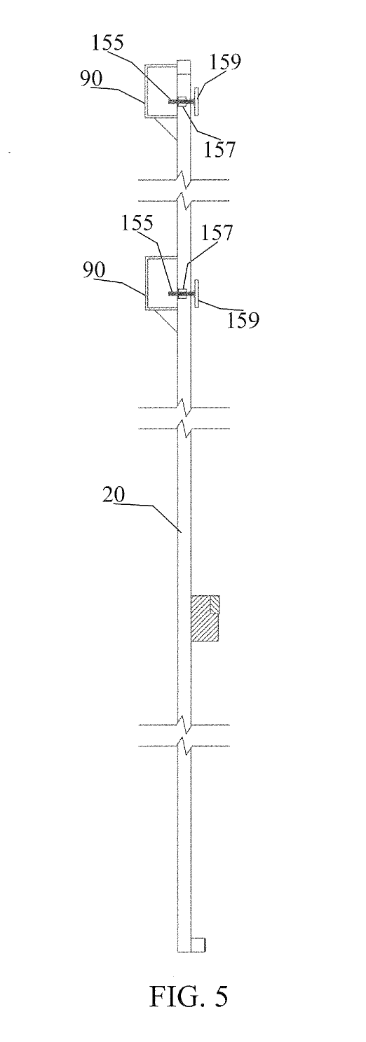

Other embodiments can utilize various coupling devices whereby one or more rails are placed within a rigid, semi-rigid, or flexible support 90 that is fixedly attached to a beam. In one embodiment, a support is one or more rigid flanges 92 fixedly attached to a beam, such as shown, for example in FIGS. 1, 3, 5 and 10. The rigid flange 92 can be attached at two ends to the beam to form an approximate “C”-shaped opening, an example of which is shown in FIG. 5. Alternatively, a rigid flange can be attached at only one end and project proximally, such as shown, for example, in FIGS. 1, 3, and 10. In a particular embodiment, the dimensions of a rigid flange are configured to the dimensions of the one or more rails to be placed therein, such that the rails are held securely with minimal tolerance to reduce or prevent undesirable movement therein. One or more gussets 98 can also be used, as known in the art, between the distal end of a support and the beam to lend greater strength to the flange.

The typical safety rail systems employ standard 2 inch×4 inch×8 foot boards as railings between brackets. Currently, OSHA requirements dictate that these types of rails overlap at least 6 inches on each side to account for flexibility of the boards and prevent dislocation in the event of a fall. Thus, in a specific embodiment, the dimensions of a rigid flange 90 are configured to hold and support at least one, more particularly at least two overlapping rails of 2″×4″×8′ boards, with minimal tolerance therebetween.

Alternatively, a support can be a flexible loop 95, such as, for example, a sleeve, band, or belt like structure, that can be affixed to the beam, through which the end(s) of a rail(s) can be placed. In a further embodiment, the sleeve or belt 95 can be adjustable. FIG. 3 illustrates an example of this embodiment.

The rail supports 90 on a beam can be located on any side of beam, such that the rails can be on the beam front-side or the beam back-side. Alternatively, the rails can be placed between the beams, with little or no overlapping, such as can be accomplished with slots 25, or similar embodiments. It would also be within the skill of a person trained in the art to conceive of alternative embodiments for supports or other mechanisms for securing railings to embodiments of a bracket of the subject invention. Substitution of support mechanisms other than those specifically exemplified herein are also contemplated to be within the scope of the subject invention.

Once rails 100 are positioned within rail supports 90, it can be helpful to ensure that they remain in place and/or maintain the proper overlapping distance. This can be facilitated by the use of one or more fasteners 150. A fastener can be any of a variety of devices or apparatuses capable of securing a rail within a support on a beam. In one embodiment, a fastener is a band, rope, or sleeve of material encircling one or more rails or one or more rails and a support. Alternatively, a fastener can be any of various mechanisms such as, but not limited, screws, bolts, clamps, vices, combinations thereof or other similar devices known to those with skill in the art.

In a particular embodiment, an example of which is shown in FIGS. 4 and 5, a bolt 155 is employed as a fastener 150 to apply pressure between one or more rails and the beam and/or rail support. With this embodiment, the bolt can be threaded through the beam or through the support to apply pressure to the one or more rails positioned within a support.

In an alternative embodiment, shown for example in FIGS. 4 and 5, a coupling nut 157 can be fixedly attached to the beam 20, such that the bolt can be used to apply pressure to one or more rails against the support in which they are positioned. In a further embodiment, the head of the bolt is enlarged or has an attached handle 159 allowing it to be more easily turned by hand.

The factors that can be considered by those skilled in the art with regard to the choice of materials for each of the components of a safety guard rail system and the brackets used therewith of the subject invention have been discussed above and are reasserted with regard to all components discussed herein. In a particular embodiment, the various components of a bracket are constructed of steel. In a specific embodiment, the various components are constructed of 16 and/or 20 gauge steel.

All patents, patent applications, provisional applications, and other publications referred to or cited herein are incorporated by reference in their entirety, including all figures and tables, to the extent they are not inconsistent with the explicit teachings of this specification. Additionally, the entire contents of the references cited within the references cited herein are also entirely incorporated by reference.

It should be understood that the examples and embodiments described herein are for illustrative purposes only and that various modifications or changes in light thereof will be suggested to persons skilled in the art and are to be included within the spirit and purview of this application.

It should be understood that any reference in this specification to “one embodiment,” “an embodiment,” “example embodiment,” “further embodiment,” “alternative embodiment,” etc., is for literary convenience. The implication is that any particular feature, structure, or characteristic described in connection with such an embodiment is included in at least one embodiment of the invention. The appearance of such phrases in various places in the specification does not necessarily refer to the same embodiment. Further, when a particular feature, structure, or characteristic is described in connection with any embodiment, it is submitted that it is within the purview of one skilled in the art to affect such feature, structure, or characteristic in connection with other ones of the embodiments.

The invention has been described herein in considerable detail, in order to comply with the Patent Statutes and to provide those skilled in the art with information needed to apply the novel principles, and to construct and use such specialized components as are required. However, it is to be understood that the invention can be carried out by specifically different equipment and devices, and that various modifications, both as to equipment details and operating procedures can be effected without departing from the scope of the invention itself. Further, it should be understood that, although the present invention has been described with reference to specific details of certain embodiments thereof and by examples disclosed herein, it is not intended that such details should be regarded as limitations upon the scope of the invention except as and to the extent that they are included in the accompanying claims.

I claim:

1. A safety guard rail bracket comprising:
an elongated beam having at least one proximal end and at least one distal end;
at least one footer attached at or near to the at least one distal end of the beam;
at least one brace attached to the beam between the at least one distal end and the at least one proximal end; and
at least one rail support attached to the beam and located proximal to the brace.

2. The safety guard rail bracket, according to claim 1, further comprising at least one fastener for securing at least one rail within at least one rail support.

3. The safety guard rail bracket, according to claim 1, further comprising at least one spacer for attaching the brace to the beam.

4. The safety guard rail bracket, according to claim 1, further comprising at least one handle operably connected to the beam at or near the proximal end.

5. The safety guard rail bracket, according to claim 1, further comprising at least two rail supports.

6. The safety guard rail bracket, according to claim 5, further comprising at least two fasteners.

7. The safety guard rail bracket, according to claim 1, further comprising at least two proximal end tines.

8. The safety guard rail bracket, according to claim 1, further comprising at least two distal end tines.

9. The safety guard rail bracket, according to claim 1, wherein the at least one rail support comprises a rigid flange fixedly attached to the beam.

10. The safety guard rail bracket, according to claim 1, wherein the at least one rail support comprises a flexible loop.

11. The safety guard rail bracket, according to claim 1, wherein the at least one rail support comprises a slot within the beam.

12. A safety guard rail system comprising,
at least one bracket comprising
an elongated beam having at least one proximal end and at least one distal end;
at least one footer attached at or near to the at least one distal end of the beam;
at least one brace attached to the beam between the at least one distal end and the at least one proximal end; and
at least one rail support attached to the beam proximal to the brace,
at least one rail for coupling with the at least one rail support; and
at least one anchor for positioning the at least one bracket against a structure, the anchor comprising an elongated flange having a first angled end and a second angled end,
wherein the anchor can be secured to a structure, such that the first angled end can be coupled to the brace to position the at least one bracket against the structure, with the proximal end generally higher than the distal end.

13. The safety guard rail system, according to claim 12, wherein the second angled end of the anchor is positioned on the interior of a cement block.

14. The safety guard rail system, according to claim 12, wherein the second angled end of the anchor is coupled to a secondary structure within the cement block.

15. The safety guard rail system, according to claim 12, wherein the second angled end is positioned on the exterior side of a cement block opposite to the first angled end.

16. The safety guard rail system, according to claim 12, wherein the at least one anchor comprises an anchor housing.

17. A method for constructing a safety guard rail against a structure utilizing:
two or more brackets, each bracket comprising,
an elongated beam having at least one proximal end and at least one distal end;
at least one footer attached at or near to the at least one distal end of the beam;
at least one brace attached to the beam between the at least one distal end and the at least one proximal end; and
at least one rail support attached to the beam proximal to the brace, and
at least one rail for coupling with at least one rail support in each bracket;
two or more anchors for positioning the two or more brackets against a structure, each anchor comprising a flange having a first angled end and a second angled end;
wherein the method comprises,
securing the at least two anchors to a structure, such that the first angled end of each anchor can be coupled to the brace on each of the at least two anchors;
coupling the brace on each of the at least two brackets to the first angled end of each of the at two secured anchors, so that the footer of each bracket rests against the structure, with the proximal ends of the brackets generally higher than the distal ends of the brackets; and
positioning the at least one rail between the brackets within the rail supports on each bracket.

18. The method, according to claim 17, wherein securing the anchors to a structure comprises positioning the flange between two cement blocks during construction of the structure.

19. The method, according to claim 17, further comprising more than two brackets, more than two anchors, and more than one rail.

20. The method, according to claim 17, wherein the two or more anchors comprise two or more anchor housings and said method comprises,
securing each anchor housing within a pre-formed opening within a structure; and
coupling the brace on each bracket to a tang within each anchor housing.

21. The method, according to claim 17, further comprising at least one spacer for attaching the brace to the beam.

22. The method, according to claim 17, where the positioning of the bracket causes an angle to be formed between the beam and the structure, such that the distal end of the beam forms the apex of the angle, causing the beam to veer away from the structure towards the proximal end.

23. The method, according to claim 22, wherein the angle formed between the beam and the structure is between approximately 4° and approximately 6°, inclusive.

24. The method, according to claim 23, wherein the proximal end veers away from the structure a distance of between approximately 5 inches and approximately 10 inches from the structure.

25. The method, according to claim 17, further comprising at least one fastener for securing at least one rail within at least one rail support.
